(19) United States
(12) Patent Application Publication
(10) Pub. No.: US 2026/0242250 A1
(43) Pub. Date: Aug. 20, 2026

(54) DEVICE FOR AQUATIC MICROPLASTICS REMOVAL

(71) Applicant: PolyGone Systems, Inc., Princeton, NJ (US)

(72) Inventors: Yidian LIU, Princeton, NJ (US); Nathanial BANKS, Princeton, NJ (US)

(73) Assignee: PolyGone Systems, Inc., Princeton, NJ (US)

(21) Appl. No.: 19/164,399

(22) PCT Filed: Mar. 15, 2024
(86) PCT No.: PCT/US2024/020139

§ 371 Date: Sep. 11, 2025

Related U.S. Application Data
(60) Provisional application No. 63/452,826, filed on Mar. 17, 2023.

(51) Int. Cl. C02F 1/28; C02F 101/30; C02F 103/00

(52) U.S. Cl. CPC C02F 1/288; C02F 1/281; C02F 1/283; C02F 2101/30; C02F 2103/007

(57) ABSTRACT

An improved artificial root device for removing microplastics from aquatic environments may be provided. The device may include a mounting bracket, a drop weight, a core wire with a first end coupled to the mounting bracket and a second end coupled to the drop weight, and a plurality of silicone fibers coupled to a first portion of the core wire between the mounting bracket and the drop weight. Each silicone fiber may be composed of a silicone polymer core and an external gel coating. A linear density of the plurality of silicone fibers may be 25-100 fibers per cm of core wire in the first portion.

### CROSS-REFERENCE TO RELATED APPLICATIONS

The present application claims priority to U.S. Provisional Patent Application No. 63/452,826, filed 17 Mar. 2023, the contents of which are incorporated by reference herein in its entirety.

### TECHNICAL FIELD

The present disclosure is drawn to devices for removing microplastics from water sources.

### BACKGROUND

For over a decade, there has been a concern around the presence of microplastics in water. Microplastics are particles of predominantly synthetic polymeric composition in the micro scale, under 5 mm in size, and generally in the range is between 1 μm and 5 mm. While microplastics in relatively still bodies of water (e.g., lakes, reservoirs), microplastics in active bodies of water (rivers, streams, etc.) have been of increasing concern.

To combat the microplastic problem, phytoremediation wetlands have been deployed. However, existing phytoremediation wetlands are typically deployed in static aquatic environments like reservoirs or lakes, and cannot remain stable in currents beyond speeds of 2 m/s. This currently limits their application in active bodies of water, as most rivers typically reach speeds beyond 6 m/s, especially during storm surges.

Further, when existing phytoremediation solutions saturate and are no longer capable of removing microplastics at an acceptable rate, expand to clog up the body of water, or are not otherwise as effective as they could be, such solutions cannot be readily replaced or moved within the body of water.

As seen in PCT/US2022/020934, the contents of which are incorporated by reference herein in its entirety, at least one approach has been disclosed; however, the artificial roots disclosed in that application have multiple concerns, including: polymer use in the filters can reintroduce polymers to the aquatic environment, and biofilms form readily on natural fibers, making it challenging to clean and reuse the root systems.

### BRIEF SUMMARY

To improve on various deficiencies in the prior art, disclosed is an improved artificial root device for removing microplastics from aquatic environments. The artificial root device may include a core wire with a first end and a second end. The artificial root device may include a mounting bracket coupled to the first end. The artificial root device may include a drop weight coupled to the second end. The artificial root device may include a plurality of silicone fibers coupled to an intermediate portion of the core wire between the first end and the second end (e.g., at a distance >0 from both the first end and the second end, so at least some of the core wire extends beyond the intermediate portion in both directions). Each silicone fiber may be composed of a silicone polymer core. The silicone polymer core may include a surface treatment. The surface treatment may include where the silicone is briefly treated with ethanol, e.g., a denatured alcohol, making the surface of the silicone fibers tackier and rougher. A radial distance each silicone fiber may extend from the core wire may be constant. The core wire may include a coiled stainless steel wire. The silicone fibers may include a vinyl-terminated poly(dimethylsiloxane). The silicone fibers may include silica. The silicone fibers may include a hydroxy silicone oil. The silicone fibers may include a silicone colorant and/or powdered activated carbon. In some embodiments, the silicone fibers may be arranged with a linear density of the plurality of silicone fibers is 60-100 fibers per cm of core wire. In some embodiments, around 1200-1800 fiber strands may be used along a twisted core wire. Each silicone fiber may be made into a relatively long solid tube of, e.g., 0.75 mm+−0.03 mm in diameter, and with a length from 2.5 inches±0.01 inches to 3.0 inches±0.1 inches. The length of the filter than includes the silicone fibers may have an axial length of, e.g., 20 cm-30 cm. The core wire may extend 5 cm-10 cm above the top-most silicone fibers and may extend 1 cm-3 cm below the bottom-most silicone fibers.

### BRIEF DESCRIPTION OF DRAWINGS

The accompanying drawings, which are incorporated in and constitute a part of this specification, illustrate embodiments of the present invention and, together with a general description of the invention given above, and the detailed description of the embodiments given below, serve to explain the principles of the present invention.

FIG. 1A is an illustration of a filter device.

FIG. 1B is an illustration of a cross-section of two adjacent fibers attached to a core wire, as seen from a side view of the filter device.

FIG. 1C is an illustration of a side-view of a filter, showing deflection when exposed to a moving fluid.

FIGS. 2A and 2B are illustrations of a cross-section of silicone fibers.

FIGS. 3A and 3B are illustrations of an alternate embodiment of a device.

It should be understood that the appended drawings are not necessarily to scale, presenting a somewhat simplified representation of various features illustrative of the basic principles of the invention. The specific design features of the sequence of operations as disclosed herein, including, for example, specific dimensions, orientations, locations, and shapes of various illustrated components, will be determined in part by the particular intended application and use environment. Certain features of the illustrated embodiments have been enlarged or distorted relative to others to facilitate visualization and clear understanding. In particular, thin features may be thickened, for example, for clarity or illustration.

### DETAILED DESCRIPTION

In some embodiments, a method, apparatus, system, or kit for removing microplastics from a body of water may be provided. These embodiments may best be understood with respect to the Figures.

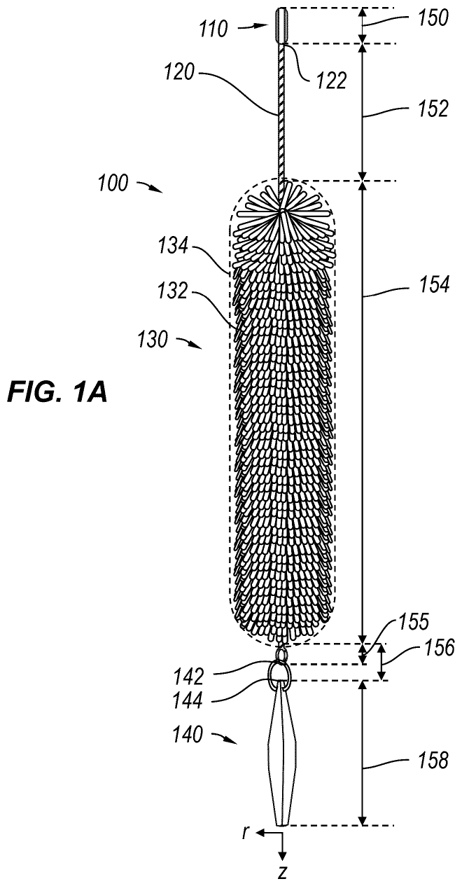

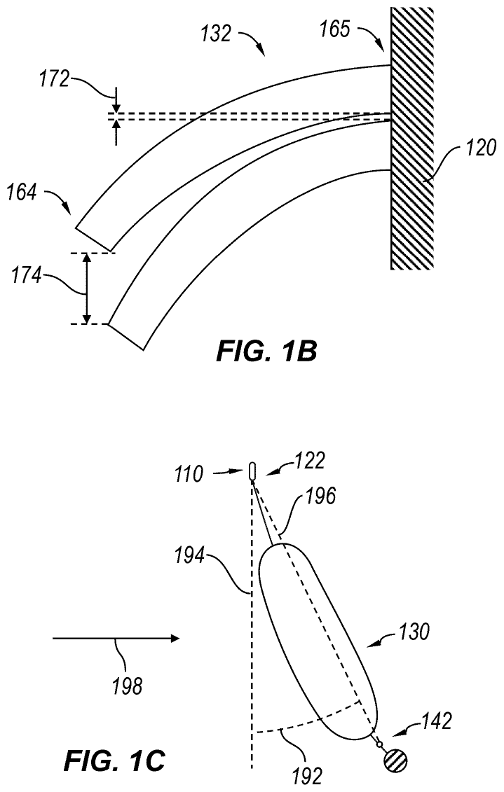

As seen in FIG. 1A, an improved artificial root for filtering microplastics from an aquatic environment may be provided. The artificial root (100) may include a core wire (120) coupled to a mounting bracket (110) at a first end (122) of the core wire and a drop weight (140) coupled to a second end (142) of the core wire. The artificial root may include a plurality of artificial fibers (130) coupled to an intermediate portion of the core wire. The intermediate portion refers to a portion of the core wire that is intermediate between the first end and the second end—that is, located a first distance greater than zero from the first end and a second distance greater than zero from the second end.

The mounting bracket (110) may be comprised of a metal or metal alloy. The mounting bracket may be stainless steel. The mounting bracket may be a polymer. The mounting bracket may have a circular cross-section (e.g., when viewed from above). The mounting bracket may have a geometric cross-section, such as hexagonal or octagonal. In one embodiment, the mounting bracket may have a hexagonal cross-section. The mounting bracket may have a length (150) (e.g., in the z-direction, parallel to the core wire) of at least 1 cm, at least 2 cm, or at least 3 cm, and up to 3 cm, up to 4 cm, or up to 5 cm, including all ranges and subranges therein. In one embodiment, the length is 2 cm-4 cm.

The core wire may preferably be composed of a metal, such as stainless steel. In some embodiments, the core wire may include a polymer (e.g., the wire may be a polymer, or the wire may include a polymeric coating over an underlying metal. In a preferred embodiment, the core wire may be comprised of a twisted coil of stainless steel. In some embodiments, the core wire may be comprised of a single wire. In some embodiments, the core wire may be comprised of a plurality of wires (e.g., two or more wires twisted together).

The plurality of artificial fibers (130) may be comprised of a silicon. The upper-most portion of the fibers may be separated from the mounting bracket by a distance (152). In some embodiments, the distance (152) may be at least 4 cm, at least 5 cm, at least 6 cm, or at least 7 cm, and up to 7 cm, up to 8 cm, up to 9 cm, or up to 10 cm.

The fibers (132) may form a generally cylindrical shape (134) with hemispherical end portions. The fibers (132) may cover a distance (154) in the z-direction of at least 15 cm, at least 18 cm, at least 20 cm, at least 22 cm, or at least 25 cm, and up to 25 cm, up to 28 cm, up to 30 cm, up to 32 cm, or up to 35 cm, including all ranges and subranges therein. In some embodiments, the fibers may be separated from the second end (142) of the core wire by a distance (155) of 1 cm to 3 cm.

In some embodiments, the total distance (156) between the bottom of the fibers and the top (144) of the drop weight (140) may be 1 cm to 5 cm.

The drop weight may have an axial length (158) (e.g., in the z-direction) of 6 cm-10 cm. In some embodiments, the axial length may be at least 4 cm, at least 5 cm, at least 6 cm, at least 7 cm, or at least 8 cm, and up to 8 cm, up to 9 cm, up to 10 cm, up to 11 cm, or up to 12 cm, including all ranges and subranges therein.

The drop weight may be configured to stabilize the filter when the filter is placed in a moving fluid (such as moving water, such as in a river). In some embodiments, this may entail having sufficient mass that the drop weight overcomes the natural buoyancy of the filter. In some embodiments, this may entail having sufficient mass that the moving fluid does not cause the filter to substantially deflect. In some embodiments, this may entail having an sufficiently aerodynamic shape such that the moving fluid does not cause the filter to substantially deflect. Referring to FIG. 1C, deflection may refer to an angle (192) formed between a first line (194) extending vertically through the top end (e.g., first end (122)) of the core wire and a second line (196) extending from the bottom end (e.g., second end (142)) of the core wire to the top end (e.g., first end (122)) of the core wire, in the direction (198) the fluid is moving. The term “substantially deflect” may refer to an angle (192) that is less than 25 degrees, preferably less than 20 degrees, more preferably less than 15 degrees, most preferably less than 10 degrees, and still most preferably less than 5 degrees. In some embodiments, the filter may be configured to operate in a fluid (such as a river) where the fluid is moving at no more than 20 kilometers per hour. In some embodiments, the filter may be configured to operate in a fluid moving at no more than 15 kilometers per hour. In some embodiments, the filter may be configured to operate in a fluid moving at no more than 10 kilometers per hour. In some embodiments, the filter may be configured to operate in a fluid moving at no more than 5 kilometers per hour.

Each fiber (132) of the plurality of fibers may have a length configured such that the fiber extends a radial distance away from the core. In some embodiments, each fiber extends substantially a same radial distance from the core (e.g., ±0.1 inches in distance). In some embodiments, each fiber may have a length of at least 2.5 inches, at least 2.6 inches, at least 2.7 inches, at least 2.8 inches, or at least 2.9 inches, and up to 2.6 inches, up to 2.7 inches, up to 2.8 inches, up to 2.9 inches, or up to 3.0 inches, including all ranges and subranges therein. In some embodiments, the lengths may vary by ±0.01 inches or less. In some embodiments, the lengths may vary by ±0.05 inches or less. In some embodiments, the lengths may vary by ±0.1 inches or less.

Each twist on the core wire will tighten a number of fiber strands into a layer. When the core wire are fully twisted, the fiber strands may form dense layers along the vertical axis of the core wire, as seen in FIG. 1A.

The distance between layers may vary. As seen in FIG. 1B, at the innermost point (165) of the fibers (132) (e.g., the point where the fibers are coupled to the wire core), the separation distance (172) may be relatively small, and may be zero (e.g., the fibers may be touching). In some embodiments, the innermost points of adjacent fibers may be separated by an axial distance of 50-200 μm. In some embodiments, the innermost points of adjacent fibers may be separated by an axial distance of at least 10 μm. In some embodiments, the innermost points of adjacent fibers may be separated by an axial distance of at least 25 μm. In some embodiments, the innermost points of adjacent fibers may be separated by an axial distance of at least 50 μm. In some embodiments, the innermost points of adjacent fibers may be separated by an axial distance of at least 75 μm. In some embodiments, the innermost points of adjacent fibers may be separated by an axial distance of at least 100 μm. In some embodiments, the innermost points of adjacent fibers may be separated by an axial distance of no more than 300 μm. In some embodiments, the innermost points of adjacent fibers may be separated by an axial distance of no more than 250 μm. In some embodiments, the innermost points of adjacent fibers may be separated by an axial distance of no more than 200 μm. In some embodiments, the innermost points of adjacent fibers may be separated by an axial distance of no more than 150 μm. In some embodiments, the innermost points of adjacent fibers may be separated by an axial distance of no more than 100 μm. In some embodiments, the innermost points of adjacent fibers may be separated by an axial distance of no more than 75 μm. In some embodiments, the innermost points of adjacent fibers may be separated by an axial distance of no more than 50 μm.

However, at outermost points (164) of the fibers, the distance (174) between fibers may be relatively larger than the separation distance (172) at the innermost points. In some embodiments, the distance (174) in the z-direction may be 1 mm-5 mm. In some embodiments, the distance may be at least 0.5 mm. In some embodiments, the distance may be at least 1 mm. In some embodiments, the distance may be at least 2 mm. In some embodiments, the distance may be at least 3 mm. In some embodiments, the distance may be at least 4 mm. In some embodiments, the distance may be no more than 10 mm. In some embodiments, the distance may be no more than 9 mm. In some embodiments, the distance may be no more than 8 mm. In some embodiments, the distance may be no more than 7 mm. In some embodiments, the distance may be no more than 6 mm.

In some embodiments, in the areas where the fibers are present, the plurality of fibers may be provided at a linear density of 60-100 fibers per cm of core wire. In some embodiments, in the areas where the fibers are present, the plurality of fibers are provided at a linear density of at least 10 fibers per cm of core wire. In some embodiments, in the areas where the fibers are present, the plurality of fibers are provided at a linear density of at least 15 fibers per cm of core wire. In some embodiments, in the areas where the fibers are present, the plurality of fibers are provided at a linear density of at least 20 fibers per cm of core wire. In some embodiments, in the areas where the fibers are present, the plurality of fibers are provided at a linear density of at least 25 fibers per cm of core wire. In some embodiments, in the areas where the fibers are present, the plurality of fibers are provided at a linear density of at least 30 fibers per cm of core wire. In some embodiments, in the areas where the fibers are present, the plurality of fibers are provided at a linear density of at least 40 fibers per cm of core wire. In some embodiments, in the areas where the fibers are present, the plurality of fibers are provided at a linear density of at least 50 fibers per cm of core wire. In some embodiments, in the areas where the fibers are present, the plurality of fibers are provided at a linear density of at least 75 fibers per cm of core wire. In some embodiments, in the areas where the fibers are present, the plurality of fibers are provided at a linear density of no more than 300 fibers per cm of core wire. In some embodiments, in the areas where the fibers are present, the plurality of fibers are provided at a linear density of no more than 250 fibers per cm of core wire. In some embodiments, in the areas where the fibers are present, the plurality of fibers are provided at a linear density of no more than 200 fibers per cm of core wire. In some embodiments, in the areas where the fibers are present, the plurality of fibers are provided at a linear density of no more than 150 fibers per cm of core wire. In some embodiments, in the areas where the fibers are present, the plurality of fibers are provided at a linear density of no more than 100 fibers per cm of core wire. In some embodiments, in the areas where the fibers are present, the plurality of fibers are provided at a linear density of no more than 75 fibers per cm of core wire.

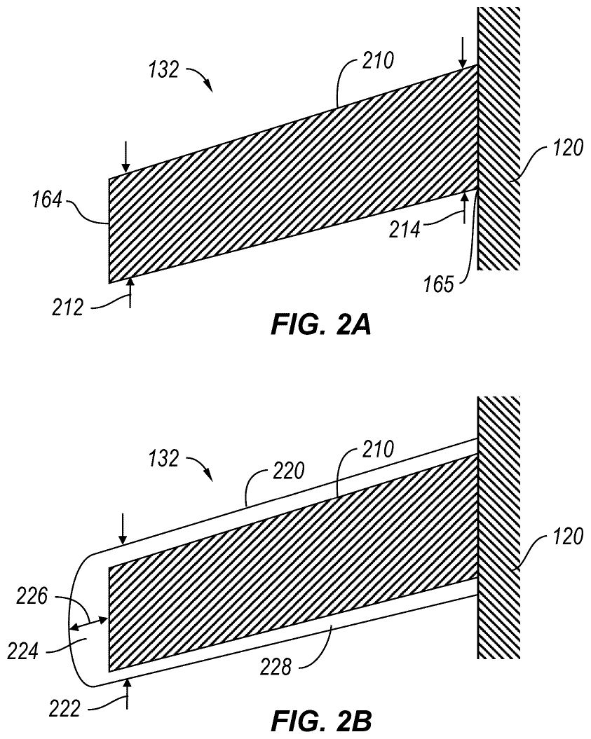

As discussed previously, and referring to FIG. 2A, each fiber (132) may be comprised of a silicone polymer, which may define a silicone polymer core (210).

Each silicone fiber may be formed of an elongated member (or tube, etc.). The silicone composition may include one or more polysiloxanes. A preferred polysiloxane is a di-Me Me vinyl vinyl group-terminated polysiloxane. Vinyl-terminated poly(dimethylsiloxane) may be represented as:

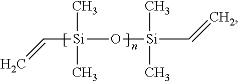

where n may be any positive integer. n is typically selected such that the molecular weight is in a desirable range. In some embodiments, the molecular weight may be at least 10,000 Daltons, at least 15,000 Daltons, at least 20,000 Daltons, or at least 25,000 Daltons, and up to 250,000 Daltons, up to 500,000 Daltons, or up to 1,000,000 Daltons. In some embodiments, the polysiloxane may be present in a total amount of at least 60%, at least 61%, at least 62%, at least 63%, at least 64%, or at least 65%, and up to 70%, up to 71%, up to 72%, up to 73%, up to 74%, or up to 75% by weight of the silicone composition, including all ranges and subranges included therein. In one preferred embodiment, the polysiloxane may be present in a concentration of 66%-68% by weight of the silicone composition.

The silicone composition may include silica. The silica may include nano-scale particles (e.g., having an average particle size D50 of less than 100 nm, as measured using standard test methods). The silica may be present in a total amount of at least 25%, at least 26%, at least 27%, at least 28%, at least 29%, or at least 30%, and up to 32%, up to 33%, up to 34%, or up to 35% by weight of the silicone composition, including all ranges and subranges included therein. In one preferred embodiment, the silica may be present in a concentration of 30%-32% by weight of the silicone composition. In some embodiments, the silicone composition may be free of silica.

The silicone composition may include a hydroxy silicone oil. The term “hydroxy silicone oil” may refer to a linear polysiloxane having at least one terminal hydroxyl group, which remains in a liquid state at room temperature. The hydroxy silicone oil may be present in a total amount of at least 0.1%, at least 0.5%, at least 1%, or at least 1.5%, and up to 2.5%, up to 3%, up to 3.5%, up to 4%, up to 4.5%, or up to 5% by weight of the silicone composition, including all ranges and subranges included therein. In one preferred embodiment, the hydroxy silicone oil may be present in a concentration of 1.5%-2.5% by weight of the silicone composition. In some embodiments, the silicone composition may be free of a hydroxy silicone oil.

The silicone composition may include a silicone colorant (e.g., a colorant compatible with the silicone composition). Any such silicone colorant known in the art may be utilized. The silicone colorant may be present in a total amount of at least 0.1%, at least 0.5%, at least 1%, at least 1.5%, or at least 2%, and up to 2.5%, up to 3%, up to 3.5%, up to 4%, up to 4.5%, or up to 5% by weight of the silicone composition, including all ranges and subranges included therein. In one preferred embodiment, the hydroxy silicone oil may be present in a concentration of 1.5%-2.5% by weight of the silicone composition. In some embodiments, the silicone composition may be free of a silicone colorant.

The silicone composition may include an adsorbent material. The adsorbent material may be, e.g., a carbonaceous adsorbent material. The carbonaceous adsorbent material may include, e.g., activated carbon. A preferred embodiment may utilize powdered activated carbon. The adsorbent material may be present on an external surface of the silicone composition. For example, on each fiber, the adsorbent material may have a free surface able to interact with, and adsorb, contaminants in the water. In some embodiments, the entire outer surface of each fiber may include the adsorbent material. In some embodiments, some external surfaces (but not all) of each fiber may be free of the adsorbent material. In some embodiments, some fibers (but not all) may be free of the adsorbent material. In some embodiments, the silicone composition may be free of an adsorbent material. The adsorbent material may be present in any appropriate amount. The adsorbent material may be present in a total amount of at least 0.01%, at least 0.1%, at least 0.5%, at least 1%, at least 1.5%, or at least 2%, and up to 5%, up to 8%, up to 10%, up to 15%, up to 20%, or up to 25% by weight of the silicone composition, including all ranges and subranges included therein.

Such compositions may be produced by, e.g., mixing all of the composition components at an elevated temperature, extruding the composition into fibers, and vulcanizing (e.g., using heat, UV, etc.) the fibers.

The fibers may include a surface treatment, e.g., to make the surface of the silicone fibers tackier and rougher. The surface treatment may include where the silicone is briefly treated with ethanol, e.g., a denatured alcohol. This may include exposure to the ethanol for a period of time that is less than 1 hour.

The silicone fibers may be configured to collect microplastics from a fluid comprising water (e.g., river water, waste treatment water, etc.). In some embodiments, this may include having a sufficiently high density of fibers. In some embodiments, this may include having silicone surfaces that are not treated in a manner that prevents the plastics from adhering or mechanically getting trapped by the filter.

The silicone polymer core may have a diameter (212) or thickness at an end of the fiber away from the core (e.g., at or near the outermost point (164)). The diameter or thickness may be 0.25-1 mm. The diameter or thickness may be 0.5-1 mm. In some embodiments, the diameter or thickness may be at least 0.1 mm. In some embodiments, the diameter or thickness may be at least 0.15 mm. In some embodiments, the diameter or thickness may be at least 0.2 mm. In some embodiments, the diameter or thickness may be at least 0.25 mm. In some embodiments, the diameter or thickness may be at least 0.5 mm. In some embodiments, the diameter or thickness may be at least 0.75 mm. In some embodiments, the diameter or thickness may be no more than 3 mm. In some embodiments, the diameter or thickness may be no more than 2.5 mm. In some embodiments, the diameter or thickness may be no more than 2 mm. In some embodiments, the diameter or thickness may be no more than 1.5 mm. In some embodiments, the diameter or thickness may be no more than 1 mm. In some embodiments, the diameter or thickness may be no more than 0.75 mm. In some embodiments, the diameter or thickness may be no more than 0.5 mm. In some embodiments, the diameter or thickness may be at least 0.75 mm+0.3 mm.

The silicone polymer core may have a diameter (214) or thickness at the end of the fiber closest to the core (e.g., at or near the innermost point (165). The diameter or thickness may be 0.25-1 mm. In some embodiments, the diameter or thickness may be at least 0.1 mm. In some embodiments, the diameter or thickness may be at least 0.15 mm. In some embodiments, the diameter or thickness may be at least 0.2 mm. In some embodiments, the diameter or thickness may be at least 0.25 mm. In some embodiments, the diameter or thickness may be at least 0.5 mm. In some embodiments, the diameter or thickness may be at least 0.75 mm. In some embodiments, the diameter or thickness may be no more than 3 mm. In some embodiments, the diameter or thickness may be no more than 2.5 mm. In some embodiments, the diameter or thickness may be no more than 2 mm. In some embodiments, the diameter or thickness may be no more than 1.5 mm. In some embodiments, the diameter or thickness may be no more than 1 mm. In some embodiments, the diameter or thickness may be no more than 0.75 mm. In some embodiments, the diameter or thickness may be no more than 0.5 mm. In some embodiments, the diameter at the outermost end is equal to the diameter at the innermost end. In some embodiments, the diameter at the outermost end is less than the diameter at the innermost end. In some embodiments, the diameter along the length of the fiber is constant. In some embodiments, the along the length of the fiber may vary.

In FIG. 2B, each fiber may include an outer layer (220) or coating around some or all of the silicone polymer core (210). In some embodiments, the coating may have a thickness (226) such that a total diameter (222) or thickness of the fiber at the end of the fiber away from the core (e.g., at or near the outermost point 164) may be no more than twice the diameter (212) or thickness of the silicone polymer core at that point. In some embodiment, the total diameter or thickness may be no more than 1.5 times the diameter or thickness of the silicone polymer core at that point. In some embodiment, the total diameter or thickness may be no more than 1.25 times the diameter or thickness of the silicone polymer core at that point.

In some embodiments, the thickness (226) of the outer layer (220) or coating may be substantially constant (e.g., varying by no more than 10% in thickness). In some embodiments, a first portion (224) of the outer layer or coating may have a thickness at least 10% thicker than a thickness at a second portion (228). In some embodiments, the first portion may be a portion between an end of the silicone polymer core and an end of the fiber.

In some embodiments, the coating may include a second silicone composition as disclosed herein, which may be different from the silicone composition of the core.

In some embodiments, the coating may include a polysiloxane as disclosed herein. In some embodiments, the coating may be free of polysiloxane. In some embodiments, the coating may include a hydroxy silicone oil as disclosed herein. In some embodiments, the coating may be free of a hydroxy silicone oil. In some embodiments, the coating may include silica as disclosed herein. In some embodiments, the coating may be free of silica. In some embodiments, the coating may include a colorant material as disclosed herein. In some embodiments, the coating may be free of a colorant. In some embodiments, the coating may include a colorant material as disclosed herein. In some embodiments, the coating may be free of a colorant. In some embodiments, the coating may include an adsorbent material as disclosed herein. In some embodiments, the coating may be free of an adsorbent material. In some embodiments, the fiber may be free of a coating.

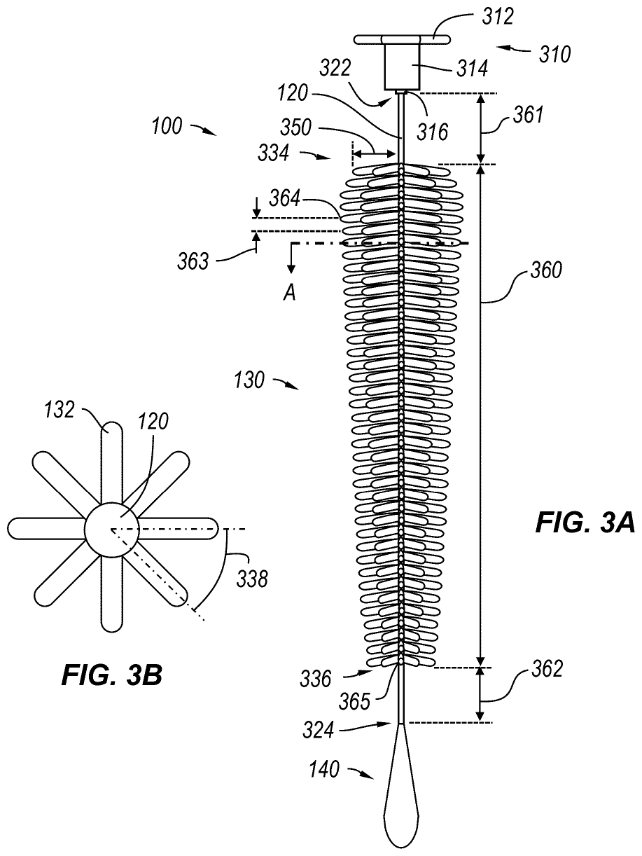

Referring to FIGS. 3A and 3B, alternate embodiments of the filters can be seen. The artificial root (100) may include a core wire (120) coupled to a mounting bracket (310) at a first end (322) of the core wire and a drop weight (140) at a second end (324) of the core wire. The artificial root may include a plurality of artificial fibers (130) coupled to the core wire.

The mounting bracket may include a top portion (312) and a bottom portion (314). The top portion may have an outer diameter that is larger than an axial length (e.g., in the z-direction) of the top portion. The central axis of the core wire may be used to define the direction of the axis. The top portion may have a geometric cross-section, such as a hexagonal or octagonal shape. The bottom portion may have an outer diameter that is smaller than the outer diameter of the top portion. The bottom portion may have an axial length that is larger than the outer diameter of the bottom portion. In some embodiments, the bottom portion may include a connector (316) to couple the core wire to the mounting bracket. This may include, e.g., a molded element the core wire is configured to be permanently or removably attached to.

The core wire may preferably be composed of a metal, such as stainless steel. In some embodiments, the core wire may include a polymer (e.g., the wire may be a polymer, or the wire may include a polymeric coating over an underlying metal.

The plurality of artificial fibers (130) may be comprised of a silicon. Each fiber (132) of the plurality of fibers may have a length configured such that the fiber extends a radial distance (350) away from the core. In some embodiments, each fiber extends a same radial distance from the core. In some embodiments, the radial distance varies along the length of the core wire (i.e., from a first end (334) to a second end (336)).

In some embodiments, the radial distance (350) any fiber on the device may extend away from the core may be 25-50 cm.

In some embodiments, where each set contains a plurality of fibers at a certain axial position (e.g., an axial distance (361) from the mounting bracket), where the fibers in the set are arranged around the core wire.

Referring briefly to FIG. 3B, it can be seen that the fibers may be arranged such that there is a circumferential angle (338) between adjacent fibers.

Each set of fibers may be separated from an adjacent set of fibers (at outermost points (364)/tips/points furthest from the wire core) by an axial distance (363). In some embodiments, the distance may be between 1 mm and 5 mm. In some embodiments, the distance may be at least 0.5 mm. In some embodiments, the distance may be at least 1 mm. In some embodiments, the distance may be at least 2 mm. In some embodiments, the distance may be at least 3 mm. In some embodiments, the distance may be at least 4 mm. In some embodiments, the distance may be no more than 10 mm. In some embodiments, the distance may be no more than 9 mm. In some embodiments, the distance may be no more than 8 mm. In some embodiments, the distance may be no more than 7 mm. In some embodiments, the distance may be no more than 6 mm.

At the innermost points (365) (e.g., the point where the fibers are coupled to the wire core), the fibers may be in contact with an adjacent fiber. In some embodiments, the innermost points of adjacent fibers may be separated by an axial distance of 50-200 μm. In some embodiments, the innermost points of adjacent fibers may be separated by an axial distance of at least 10 μm. In some embodiments, the innermost points of adjacent fibers may be separated by an axial distance of at least 25 μm. In some embodiments, the innermost points of adjacent fibers may be separated by an axial distance of at least 50 μm. In some embodiments, the innermost points of adjacent fibers may be separated by an axial distance of at least 75 μm. In some embodiments, the innermost points of adjacent fibers may be separated by an axial distance of at least 100 μm. In some embodiments, the innermost points of adjacent fibers may be separated by an axial distance of no more than 300 μm. In some embodiments, the innermost points of adjacent fibers may be separated by an axial distance of no more than 250 μm. In some embodiments, the innermost points of adjacent fibers may be separated by an axial distance of no more than 200 μm. In some embodiments, the innermost points of adjacent fibers may be separated by an axial distance of no more than 150 μm. In some embodiments, the innermost points of adjacent fibers may be separated by an axial distance of no more than 100 μm. In some embodiments, the innermost points of adjacent fibers may be separated by an axial distance of no more than 75 μm. In some embodiments, the innermost points of adjacent fibers may be separated by an axial distance of no more than 50 μm.

In some embodiments, in the areas where the fibers are present, the plurality of fibers are provided at a linear density of 60-100 fibers per cm of core wire. In some embodiments, in the areas where the fibers are present, the plurality of fibers are provided at a linear density of at least 10 fibers per cm of core wire. In some embodiments, in the areas where the fibers are present, the plurality of fibers are provided at a linear density of at least 15 fibers per cm of core wire. In some embodiments, in the areas where the fibers are present, the plurality of fibers are provided at a linear density of at least 20 fibers per cm of core wire. In some embodiments, in the areas where the fibers are present, the plurality of fibers are provided at a linear density of at least 25 fibers per cm of core wire. In some embodiments, in the areas where the fibers are present, the plurality of fibers are provided at a linear density of at least 30 fibers per cm of core wire. In some embodiments, in the areas where the fibers are present, the plurality of fibers are provided at a linear density of at least 40 fibers per cm of core wire. In some embodiments, in the areas where the fibers are present, the plurality of fibers are provided at a linear density of at least 50 fibers per cm of core wire. In some embodiments, in the areas where the fibers are present, the plurality of fibers are provided at a linear density of at least 75 fibers per cm of core wire. In some embodiments, in the areas where the fibers are present, the plurality of fibers are provided at a linear density of no more than 300 fibers per cm of core wire. In some embodiments, in the areas where the fibers are present, the plurality of fibers are provided at a linear density of no more than 250 fibers per cm of core wire. In some embodiments, in the areas where the fibers are present, the plurality of fibers are provided at a linear density of no more than 200 fibers per cm of core wire. In some embodiments, in the areas where the fibers are present, the plurality of fibers are provided at a linear density of no more than 150 fibers per cm of core wire. In some embodiments, in the areas where the fibers are present, the plurality of fibers are provided at a linear density of no more than 100 fibers per cm of core wire. In some embodiments, in the areas where the fibers are present, the plurality of fibers are provided at a linear density of no more than 75 fibers per cm of core wire.

The plurality of fibers may be present along a portion of the core wire. The first end (334) of the plurality of fibers may be separated by an axial distance (361) from the mounting bracket (310). The second end (336) of the plurality of fibers may be separated by an axial distance (360) from the first end. The drop weight (140) may be separated from the second end by an axial distance (362).

In various aspects, the artificial root devices may be configured to remove microplastics from a fluid. One or more artificial root devices (and preferably a plurality of artificial root devices, arranged in an array) may be suspended in a fluid containing microplastics, such that the plurality of fibers are submerged in the fluid. The fluid may be allowed to flow through the root devices for a period of time, such that microplastics within the fluid may interact with the artificial root devices. The artificial root devices may adhere or entangle the microplastics. The artificial root devices may then be removed from the fluid, thereby removing at least some of the microplastics from the fluid.

The use of silicone does not reintroduce, e.g., microplastics back into the aquatic environment. Surprisingly, when embodiments of the present disclosure are placed in an aquatic environment containing microplastics, the artificial roots have captured 74% of microplastics in a laboratory environment after 24 hours of exposure. In one embodiment, a single filter captured 63 particles after 2 hours of exposure in a canal, and over 1300 particles after 4 weeks in a lake. Further, substantially less biofilm was formed on the surface of the fibers, as compared to natural fibers, making it far easier to clean and reuse the devices.

For example, in a 3-day continuous use trial, devices using coconut fiber had large quantities of algae visibly growing on the fibers, while the silicone fibers had no such large-scale algae growth. However, very small quantities of biofilm was found to have formed on the silicone fiber filter after 3 days of continuous use in our lab, but nowhere near the extent found on the coconut fiber filters.

The disclosed filters can be easily cleaned, e.g., by lightly scrubbing the brush with water and mild detergent for 5 minutes, or by rotating while fully submerged in water with a mild detergent. As used herein, “mild detergent” refers to the use of a cleaning agent (which may include, e.g., surfactants/emulsifiers) that can remove foreign materials from the surface of the filter without degrading the filter material itself. Non-limiting examples of mild detergents include, e.g., conventional dish soaps or laundry detergents.

Embodiments of the present disclosure are described in detail with reference to the figures wherein like reference numerals identify similar or identical elements. It is to be understood that the disclosed embodiments are merely examples of the disclosure, which may be embodied in various forms. Well known functions or constructions are not described in detail to avoid obscuring the present disclosure in unnecessary detail. Therefore, specific structural and functional details disclosed herein are not to be interpreted as limiting, but merely as a basis for the claims and as a representative basis for teaching one skilled in the art to variously employ the present disclosure in virtually any appropriately detailed structure.

Those skilled in the art will recognize or be able to ascertain using no more than routine experimentation many equivalents to the specific embodiments of the invention described herein. Such equivalents are intended to be encompassed by the following claims.

1. An artificial root device for removing microplastics from aquatic environments, comprising:
a core wire having a first end and a second end; and
a plurality of silicone fibers coupled to an intermediate portion of the core wire, the intermediate portion being a first distance from the first end and a second distance from the second end, the first distance and the second distance being greater than zero.

2. The artificial root device of claim 1, wherein each silicone fiber comprises a silicone polymer core.

3. The artificial root device of claim 2, wherein the silicone polymer core has an average diameter of 0.5-1 mm.

4. The artificial root device of claim 1, wherein a radial distance each silicone fiber extends from the core wire is constant.

5. The artificial root device of claim 1, wherein the core wire comprises a coiled stainless steel wire.

6. The artificial root device of claim 1, wherein the plurality of silicone fibers comprise a vinyl-terminated poly(dimethylsiloxane).

7. The artificial root device of claim 1, wherein the plurality of silicone fibers comprise a silicone colorant and/or powdered activated carbon.

8. The artificial root device of claim 1, wherein the plurality of silicone fibers are configured to collect microplastics from a fluid comprising water.

9. The artificial root device of claim 1, wherein a linear density of the plurality of silicone fibers is 60-100 fibers per cm of core wire.

10. The artificial root device of claim 1, further comprising a mounting bracket coupled to a first end of the core wire.

11. The artificial root device of claim 1, further comprising a drop weight coupled to a second end of the core wire.

12. The artificial root device of claim 11, wherein the drop weight is configured to stabilize the artificial root device when the artificial root device is placed in moving water.

13. A method, comprising:
placing an artificial root device of claim 1 in a fluid comprising microplastics, such that the plurality of silicone fibers are submerged in the fluid;
allowing the microplastics to interact with the plurality of silicone fibers; and
removing the artificial root device, where one or more microplastic particles from the fluid are adhered or entangled in the artificial root device.
